(19) United States
(12) Patent Application Publication
(10) Pub. No.: US 2023/0144428 A1
(43) Pub. Date: May 11, 2023

(54) Method for Preventing a Non-Authorized Using of an Aerosol Generation Device in a Restricted Area and Associated System

(71) Applicant: JT International SA, Geneva (CH)

(72) Inventors: Andrew Robert John Rogan, Forres (GB); Stephane Hedarchet, Geneva (CH)

(73) Assignee: JT International SA, Geneva (CH)

(21) Appl. No.: 17/911,834

(22) PCT Filed: Mar. 18, 2021
(86) PCT No.: PCT/EP2021/056913

§ 371 Date: Sep. 15, 2022

(30) Foreign Application Priority Data
Mar. 20, 2020 (EP) 20164616.3

(51) Int. Cl. A24F 40/53; A24F 40/65; A24F 40/57

(52) U.S. Cl. CPC A24F 40/53; A24F 40/57; A24F 40/65

(57) ABSTRACT

The present invention concerns a method (60) for preventing a non-authorized using of an aerosol generation device in a restricted area, comprising the following of determining (61) a device characteristic; comparing (65) the device characteristic with an updatable database to generate a control signal for the aerosol generation device, the database comprising control characteristics of aerosol generation devices authorizing or non-authorizing using the corresponding aerosol generation device according to emission restrictions in the restricted area; and transmitting (67) to a control unit of the device the control signal, the control signal causing determining adjusted operational settings to adjust the operation of the aerosol generation device according to the emission restrictions in the restricted area.

### FIELD OF THE INVENTION

The present invention concerns a method for preventing a non-authorized using of an aerosol generation device in a restricted area.

The present invention concerns also a system configured to implement such a method.

### BACKGROUND OF THE INVENTION

Different types of aerosol generation devices are already known in the art. Generally, such devices comprise a storage portion for storing an aerosol forming precursor, which can comprise for example a liquid or in a form of tobacco stick. A heating system is formed of one or more electrically activated resistive heating elements arranged to heat said precursor to generate the aerosol. The aerosol is released into a flow path extending between an inlet and outlet of the system. The outlet may be arranged as a mouthpiece, which a user inhales through for delivery of the aerosol.

In some areas, using of an aerosol generation devices can be restricted or even prohibited. Such areas may be notably train stations, schools and airports.

In order to prevent a non-authorized using of an aerosol generation device in such areas, called hereinafter restricted areas, different methods making it possible to disable operation of the aerosol generation devices in these areas are already known in the state of the art.

Thus, for example, one of these methods consists in diffusing a special wireless beacon in the restricted area. Upon receiving such a wireless beacon, switching means comprised in each aerosol generation device are configured to disable the operation of the corresponding device. The device can be operated again when no wireless beacon is received that means that the device is no longer in the restricted area.

Some other methods consist in determining the location of an aerosol generation device using for example a GPS receiver and comparing this location with a memorized map comprising restricted areas. When the device is in a restricted area according to this map, its operation is disabled. It can be then enabled when the device is no longer in such an area.

However, the existing methods are not completely satisfactory. Particularly, the operation of some modern aerosol generation devices can be adjusted basing on the restrictions imposed by a restricted area so as using of these devices can be authorized in such an area. The existing methods do not allow distinguishing such devices which can be authorized to operate in spite of the location restrictions.

### SUMMARY OF THE INVENTION

One of the aims of the invention is to improve the existing methods and make it possible to authorize or disable an aerosol generation device in restricted areas, taking into consideration of inherent characteristics of this device in addition to location restrictions.

For this purpose, the invention relates to a method for preventing a non-authorized using of an aerosol generation device in a restricted area, the aerosol generation device comprising a control unit configured to adjust the operation of the aerosol generation device according to operational settings upon receiving a control command;
the method comprising the following steps, performed when the aerosol generation device is in the restricted area:
   determining a device characteristic of the aerosol generation device;
   comparing the device characteristic of the aerosol generation device with an updatable database to generate a control signal for the aerosol generation device, the database comprising control characteristics of aerosol generation devices authorizing or non-authorizing using the corresponding aerosol generation device according to emission restrictions in the restricted area;
   transmitting to the control unit of the device the control signal, the control signal causing determining adjusted operational settings to adjust the operation of the aerosol generation device according to the emission restrictions in the restricted area.

Using these features, the method according to the invention makes it possible to determine a characteristic of the device and basing on this characteristic, authorize or not using the aerosol generation device in a restricted area. It is also possible to adjust some operational settings of the aerosol generation device so as its operation could be authorized according to the restrictions.

According to some embodiments, the device characteristic is determined by a processor of the aerosol generation device by a pre-programmed routine.

Using these features, the method according to the invention can be performed by the aerosol generation device.

According to some embodiments, the method further comprises the step of transmitting the device characteristic to a distant server.

Using these features, the updatable database can be stored on the distant server.

According to some embodiments, the step of determining the device characteristic is performed by a scan terminal upon entering the restricted area by scanning the aerosol operation device or a mobile device associated to the aerosol generation device;

the step of transmitting the device characteristic being performed by the scan terminal.

Using these features, it is possible to use scan terminals, for example upon entering the restricted area, to determine at least one characteristic of the device.

According to some embodiments, the method, further comprises the following steps:
scanning the aerosol operation device or a mobile device associated to the aerosol generation device by a scan terminal upon leaving the restricted area;
transmitting to the control unit of the device a control signal causing normal operation of the aerosol generation device.

Using these features, it is possible to use normally the aerosol generation device upon leaving the restricted area.

According to some embodiments, the steps of determining and transmitting the device characteristic are performed by a mobile device associated to the aerosol generation device.

Using these features, it is possible to associate an external mobile device to control at least partially the operation of the aerosol generation device.

According to some embodiments, the method further comprises the following steps performed upon entering the restricted area:
emitting a broadcast signal indicating entering the restricted area;
transmitting to the control unit of the device a control signal causing disabling the operation of the aerosol generation device when the broadcast signal is received;
transmitting to the control unit of the device a control signal causing normal operation of the aerosol generation device when the broadcast signal is no more received.

Using these features, it is possible to adjust automatically the operational settings of the aerosol generation device upon entering the restricted area and to operate it normally upon leaving the restricted area.

According to some embodiments, the broadcast signal is received by the aerosol generation device or by a mobile device associated to the aerosol generation device.

Using these features, it is possible to perform at least some steps of the method using the aerosol generation device itself or a mobile device associated to this aerosol generation device.

According to some embodiments, the method further comprises a step of determining a location of the aerosol generation device;

the control signal being generated further based on the location of the aerosol device using a memorized map including the restricted area.

Using these features, it is possible to adjust the operation of the aerosol generation device according to its location.

According to some embodiments, said steps are performed at least partially by the aerosol generation device or by a mobile device associated to the aerosol generation device.

Using these features, it is possible to perform at least some steps of the method using the aerosol generation device itself or a mobile device associated to this aerosol generation device.

According to some embodiments, the control signal is generated further based on restrictions imposed by the restricted area, other than the emission restrictions.

Using these features, it is possible to adjust the operation of the aerosol generation device using some restrictions, other than emission restrictions imposed by the restricted area.

According to some embodiments, each control characteristic of the updatable database comprises at least one element chosen in the group comprising:
brand and/or model of aerosol generation devices authorized or non-authorized to be used in the restricted area according to the emission restrictions;
identifier of aerosol generation devices authorized or non-authorized to be used in the restricted area according to the emission restrictions;
identifier of payloads authorized or non-authorized to be used in the restricted area according to the emission restrictions;
thresholds of authorized emission composition of the aerosol.

Using these features, it is possible to obtain the updatable database making it possible to adjust the operation of the aerosol generation device according to the restrictions imposed in the restricted area.

According to some embodiments, the device characteristic comprises at least one element chosen in the group comprising:
brand and/or model of the aerosol generation device;
identifier of the aerosol generation device;
identifier of the payload;
emission composition of the aerosol.

Using these features, it is possible to determine at least one device characteristic so as to compare it with control characteristics from the updatable database.

According to some embodiments, adjusting the operation of the aerosol generation device includes at least one element chosen in the group comprising:
heater temperature control;
aerosol composition control;
power control;
pressure control.

Using these features, it is possible to adjust the operation of the aerosol generation device so as to satisfy the restrictions imposed by the restricted area.

The invention also relates to a system for preventing a non-authorized using of an aerosol generation device in a restricted area, configured to implement the method as defined above.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic diagram showing an aerosol generation device;

FIG. 2 is a schematic diagram showing a system for preventing a non-authorized using of an aerosol generation device, according to a first embodiment of the invention;

FIG. 3 is a flowchart of a method for preventing a non-authorized using of an aerosol generation device, performed by the system of FIG. 2;

FIG. 4 is a schematic diagram showing a system for preventing a non-authorized using of an aerosol generation device, according to a second embodiment of the invention;

FIG. 5 is a flowchart of a method for preventing a non-authorized using of an aerosol generation device, performed by the system of FIG. 4;

FIG. 6 is a schematic diagram showing a system for preventing a non-authorized using of an aerosol generation device, according to a third embodiment of the invention;

FIG. 7 is a flowchart of a method for preventing a non-authorized using of an aerosol generation device, performed by the system of FIG. 6;

FIG. 8 is a schematic diagram showing a system for preventing a non-authorized using of an aerosol generation device, according to a fourth embodiment of the invention;

FIG. 9 is a schematic diagram showing a system for preventing a non-authorized using of an aerosol generation device, according to a fifth embodiment of the invention; and

FIG. 10 is a flowchart of a method for preventing a non-authorized using of an aerosol generation device, performed by the system of FIG. 9.

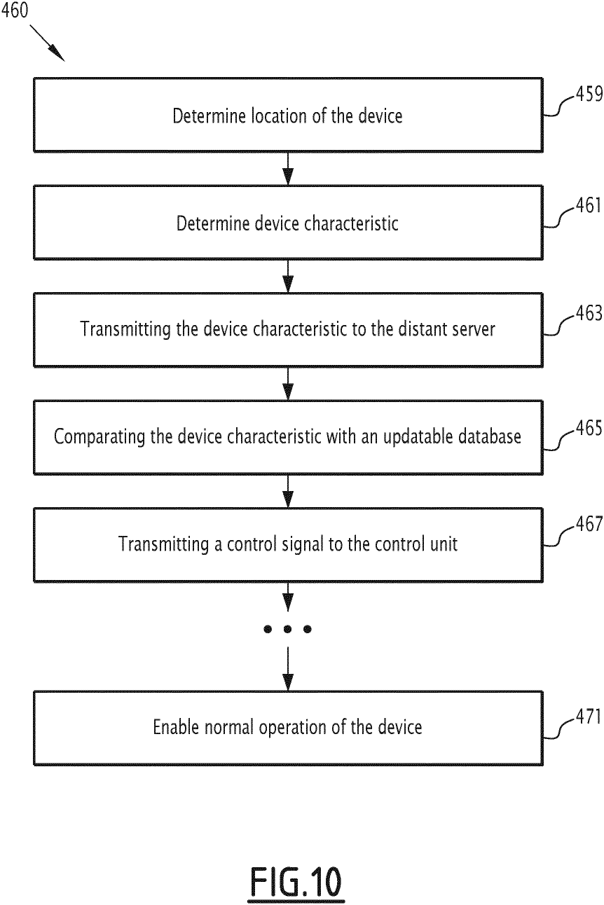

### DETAILED DESCRIPTION OF THE INVENTION

Before describing the invention, it is to be understood that it is not limited to the details of construction or process steps set forth in the following description. It will be apparent to those skilled in the art having the benefit of the present disclosure that invention is capable of other embodiments and of being practiced or being carried out in various ways.

As used herein, the term “aerosol generation device” or “device” may include a smoking device to deliver an aerosol to a user, including an aerosol for smoking, by means of aerosol generating unit (e.g. a heater or atomizer which generates vapor which condenses into an aerosol before delivery to an outlet of the device at, for example, a mouthpiece, for inhalation by a user. The device may be portable. “Portable” may refer to the device being for use when held by a user. The device may be adapted to generate a variable amount of aerosol, e.g. by activating an atomizer for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation so as to enable more or less vapor to be provided based on the strength of inhalation (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature regardless of the amount of substrate (pre-cursor) available at the aerosol generating unit and regardless of the strength with which a user inhales. More generally, the aerosol generation device can comprise a control unit configured to adjust the device according to operational settings. Thus, the control unit can control the operation of the heater and/or the power provided for example by a battery and/or the pressure of the precursor or the air.

As used herein, the term “operational settings” may refer to settings usable by the control unit of the device to control the operation of the device. The operational settings may thus refer to a temperature of the heater and/or current or voltage values provided by the battery and/or precursor or air pressure values. The operational settings may be normal and adjusted. The normal operational settings are used when the device is operated normally, i.e. without restrictions. In this case, all functions of the device are workable in a default setting or in a default operation mode to enable full capacity of aerosol generation. The adjusted operational settings are used when the device is operated under restrictions imposed for example by the area where the device is used. The adjusted operational setting may adjust or limit some functions of the device, e.g., lower down the aerosol emission of the device. So, the adjusted operational settings make it possible to respect the restrictions. The adjusted operational settings can cause disabling operation of the aerosol generation device.

As used herein, the term “control signal” may refer to a signal transmitted to the control unit of the aerosol generation device to cause a modification in the operation of the device. For example, a control signal can cause a modification of the operational settings by the control unit of the device. A control signal can also include operational settings to be used by the control unit. According to other examples, a control signal can include an enabling signal causing normal operation of the device to generate aerosol, i.e. using normal operational settings by the control unit, an adjusting signal causing adjusted operation of the device to generate aerosol, i.e. using adjusted operational settings without disabling the device, and a disabling signal causing disabling the device to generate aerosol, i.e. using adjusted operational settings causing disabling the device to generate aerosol. According to the different embodiments of the invention, the control signal can be generated by a distant server, a local server, a scan terminal, a mobile device or the aerosol generation device.

As used herein, the term “aerosol” may include a suspension of precursor as one or more of: solid particles; liquid droplets; gas. Said suspension may be in a gas including air. Aerosol herein may generally refer to/include a vapor. Aerosol may include one or more components of the precursor.

As used herein, the term “aerosol-forming precursor” or “precursor” or “aerosol-forming substance” or “substance” or “payload” may refer to one or more of a: liquid; solid; gel; mousse; other substance. The precursor may be processable by an atomizer of the device to form an aerosol as defined herein. The precursor may comprise one or more of: nicotine; caffeine or other active component. The active component may be carried with a carrier, which may be a liquid. The carrier may include propylene glycol or glycerine. A flavoring may also be present. The flavoring may include Ethylvanillin (vanilla), menthol, Isoamyl acetate (banana oil) or similar. A solid aerosol forming substance may be in the form of a rod, which contains processed tobacco material, a crimped sheet or oriented strips of reconstituted tobacco (RTB).

As used herein, the term “emission restrictions” may refer to one or more components of the aerosol generated by the device, which is not authorized or limited in a given area. These components can be Nicotine, Hoffmann analytes, Formaldehyde, metal substance such as chromium, lead, nickel, etc.

The emission restrictions may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. The restrictions may be presented by thresholds relative to the corresponding components of the aerosol. Each threshold is a non-zero value. These thresholds may be expressed in mass unities, volume unities and/or part unities such “%” for example. These unities can be expressed per puff or per predetermined number of puffs as explained above.

The emission restrictions may vary according to the area (country, region, city, restricted area, etc.).

The emission restrictions may be defined by authorities for a given restricted area or any other administration responsible for the restricted area. The restrictions may depend on external parameters, such as time, day of the week, season, weather, pollution level, special using of the restricted area, etc. The restrictions may be updated in real time or according to a predetermined period. The emission restrictions may reflect test measures performed to obtain an emission test report relative to a particular brand and/or model of the aerosol generation device or any other device characteristic such for example its identifier.

As used herein, the term “test report” or “emission test report” may refer to a test or a series of tests performed in relation with a particular brand and/or model of an aerosol generation device or any other device characteristic such for example its identifier, notably to obtain an authorization from market authorities, for example before launching the aerosol generation device to the market. These tests are for example conducted to measure the quantity of components in the aerosol generated by one or several aerosol generation devices representative of the given brand and/or model or any other device characteristic. The measures may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. These measures may be expressed in mass unities, volume unities and/or part unities such “%” for example. These unities can be expressed per puff or per predetermined number of puffs as explained above. Each test report may be stored in a distant database of the market authorities and/or the device and/or substance manufacturer. This database can be publically accessible.

As used herein, the term “restricted area” may refer to a fixed geographical zone or location, or a movable area. In the first case, it may be notably a school, a stadium, an airport, a bus/train station, a hospital, a hotel, a restaurant or more generally, a neighborhood, a village or a city. In the second case, it may be a transport mean, notably a public transport mean like a bus, a train, an aircraft, etc. or an individual transport mean like a car.

As used herein, the term “mobile device” may refer to a device, which is able to establish a data connection with the aerosol generation device. Advantageously, the computing device is also able to establish a connection with a distant server via for example a global computer network as Internet. The mobile device includes human-computer interaction means such a touch screen or a screen associated with control means, to allow a user to communicate with the distant server and with the aerosol generation device. Thus, the mobile device may be a smartphone, a laptop, a personal computer, a tablet, a smartwatch or all other connected device. In some cases, the mobile device can determine adjustable operational settings for the associated aerosol generation device.

As used herein, the term “distant server” may refer to one or several computers able to provide a distant service such for example an updatable database. The distant service can be required by a user via the aerosol generation device, the mobile device associated to this aerosol generation device or a scan terminal. In some cases, the distant server can determine adjustable operational settings for the aerosol generation device for which a service has been required. In some embodiments, the distant server can determine emission composition of the aerosol using for example only the brand and/or model of the aerosol generation device or any other device characteristic such for example its identifier. In this case, the distant server is for example able to access to the emission test report relative to this brand and/or model of the aerosol generation device or any other device characteristic.

As used herein, the term “updatable database” may refer to a database stored locally or distantly and defining control characteristics of aerosol generation devices authorizing or non-authorizing using the corresponding aerosol generation device according to the emission restrictions in the restricted area. Each control characteristic of the updatable database can refer to a brand and/or model of the aerosol generation device authorized or non-authorized to be used in the restricted area according to the emission restrictions, an aerosol generation device identifier authorized or non-authorized to be used in the restricted area according to the emission restrictions, a payload identifier authorized or non-authorized to be used in the restricted area according to the emission restrictions, or thresholds of authorized emission composition of the aerosol. In this last case, the thresholds of authorized emission composition of the aerosol may comprise a threshold for each component of the generated aerosol. Such a threshold may concern the total amount of the component generated in the period of using of the device or in any other predetermined period such for example a predetermined number of puffs (10 puffs, 20 puffs, 30 puffs, 40 puffs, 50 puffs, etc.), or a part of the component in the aerosol. These measures may be expressed in mass unities, volume unities and/or part unities such “%” for example. These unities can be expressed per puff or per predetermined number of puffs as explained above.

As used herein, the term “device characteristic” may refer to a brand and/or model of the aerosol generation device, an aerosol generation device identifier, a payload identifier or an emission composition of the aerosol.

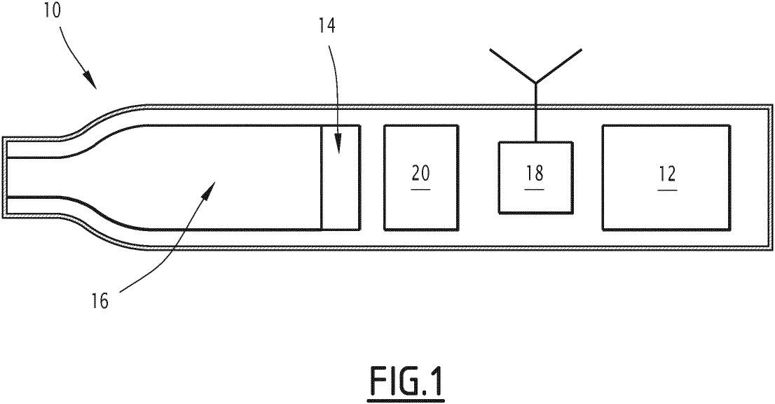

Referring to FIG. 1, an aerosol generation device 10 used in the different embodiments of the invention will be first explained.

Particularly, the aerosol generation device 10 comprises a battery 12 for powering the device, a heating system 14 powered by the battery 12, a payload compartment 16 in contact with the heating system 14, a communication unit 18 connecting the aerosol generation device 10 to at least one external device and a control unit 20 controlling the operation of the device. The aerosol generation device 10 may further comprise other components performing different functionalities of the device 10. These other components are known per se and will be not explained in further detail below.

The battery 12 is for example a known battery designed to be charged using the power supply furnished by an external charger and to provide a direct current of a predetermined voltage.

The payload compartment 16 is designed to store the precursor used to generate aerosol. Particularly, based on the nature of the precursor, the payload compartment 16 can be designed to store the precursor in a liquid and/or solid form. The payload compartment 16 can be fixed in respect with the body of the aerosol generation device 10 or removable from it. In the first case, the payload compartment 16 can be refilled with the precursor. In the second case, the payload compartment 16 can present a replaceable cartridge (e.g., a pod or capsule containing e-liquid) or consumable (e.g., a tobacco rod) that can be removed and replaced by another one when the precursor is no longer available. In some embodiments, the replaceable cartridge can be also refilled with the precursor.

In some embodiments, the payload compartment 16 may comprise a payload identifier making it possible to determine the nature of the precursor and/or its composition. The payload identifier can be transmitted to the control unit 20 and used by this unit, as it will be explained below. For example, in case of a replaceable cartridge, the payload identifier can be transmitted electronically and/or mechanically to the control unit 20. In case of a refillable payload compartment 16, the payload identifier can be determined and transmitted to the control unit 20 by appropriate electronic means. In some other embodiments, the payload identifier is transmitted by a user using an appropriate human-machine interface. Such an interface can be for example integrated directly into the aerosol generation device or into a mobile device associated with the aerosol generation device.

The heating system 14 comprises a heater in contact with the payload compartment 16 or integrated partially into this compartment 16. Powered by the battery 12 and controlled by the control unit 20, the heater is able to heat the precursor comprised in the payload compartment 16 to generate aerosol.

The control unit 20 is able to control the operation of the aerosol generation device 10, using operational settings. Particularly, using the operational settings, the control unit 14 is able to control the heater temperature and/or the power provided from the battery 12 to the heating system 14 and/or the pressure for example at the air inlet or aerosol outlet.

In some cases, the control unit 20 is also able to control the composition of the aerosol, by controlling for example the heater temperature and/or the heating duration and/or the operation of other components of the aerosol generation device 10 in an appropriate way.

In some embodiments, the control unit 20 is also able to determine at least one characteristic of the aerosol generation device 10. As mentioned above, this characteristic may comprise a device brand and/or model, a device identifier, a payload identifier and/or an emission composition of the aerosol. Such a characteristic is for example securely stored in a memory of the control unit 20.

Advantageously, the memory of the control unit 20 is also able to store normal operational settings of the device 10, i.e. the operational settings corresponding to a normal operation of the device 10.

The communication unit 18 is configured to perform for example short-range wireless communications with an external device such as a mobile device or a scan terminal or any other electronic device, when such a device is in a close position with the aerosol generation device 10. Thus, the communication unit 18 is able to perform one of the known short-range communication protocols such as Bluetooth, RFID, NFS, etc.

In some embodiments, the communication unit 18 is further configured to perform long-range wireless communications with any electronic device. Thus, the communication unit 18 is able to perform communications using one of the known long-range protocols such as Wi-Fi, LoRa, 3G, 4G, 5G, etc.

According to some embodiments, the communication unit 18 is configured only to receive data from an external device. In some other embodiments, the communication unit 18 is configured to receive data from an external device and to transmit data to such a device.

Finally, according to some embodiments, the communication unit 18 is configured to perform wire communications with an appropriate device, e.g., via a USB cable.

### First Embodiment of the Invention

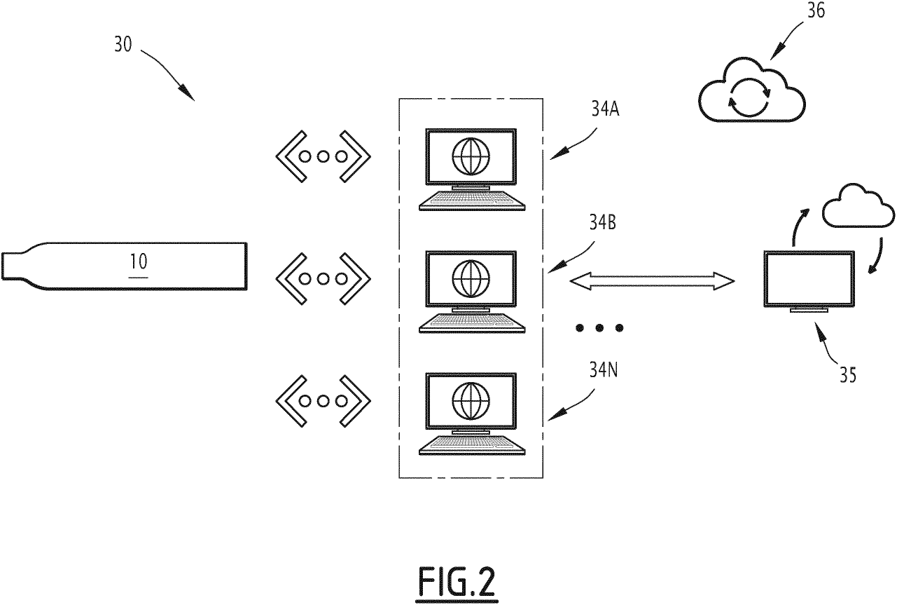

A system for preventing a non-authorized using of the aerosol generation device 10 as explained above, in a restricted area, according to a first embodiment of the invention, will now be explained in reference to FIG. 2. This system is called hereinafter preventing system and denoted by reference 30 on this figure. Thus, as it is illustrated on FIG. 2, the preventing system 30 comprises a plurality of scan terminals 34A, ..., 34N and a distant server 36.

The scan terminals 34A, ..., 34N are for example disposed at the entrance to the restricted area and/or at the exit from the restricted area. These terminals 34A, ..., 34N are configured to scan the aerosol generation device 10 in order to determine at least one device characteristic. For this purpose, each scan terminal 34A, ..., 34N comprises a communication unit able to exchange data with the communication unit 18 of the aerosol generation device 10. Particularly, the communication unit of each scan terminal 34A, ..., 34N is able to read at least one characteristic of the aerosol generation device and to transmit to the communication unit 18 of the aerosol generation device 10 a control signal.

The scan terminals 34A, ..., 34N are for example connected by wire or wirelessly to a same local server 35. The local server 35 can be chosen among the scan terminals 34A, ..., 34N or form a separate device. The local server 35 is able to communicate with the scan terminals 34A, ..., 34N and with the distant server 36 in order to exchange data between the terminals 34A, ..., 34N and the distant server 36. Particularly, the local server 35 allows transmitting the characteristic of the aerosol generation device 10 scanned by one of the terminals 34A, ..., 34N to the distant server 36 and transmitting a control signal generated by the distant server 36 to at least one of the terminals 34A, ..., 34N.

In variant, each scan terminal 34A,..., 34N is connected directly to the distant server 36 and is able to exchange directly data with this distant server 36.

The distant server 36 is for example a cloud server comprising an updatable database as defined below. Particularly, the distant server 36 is able to receive at least one characteristic of the aerosol generation device 10 and to compare this characteristic with the updatable database. Further to this comparison, the distant server 36 is able to transmit to the aerosol generation device 10 eventually via the local server 35 and via one of the scan terminals 34A, ..., 34N, a control signal. As explained below, the control signal may comprise an enabling command, a disabling command, an adjusting command or adjusted operational settings.

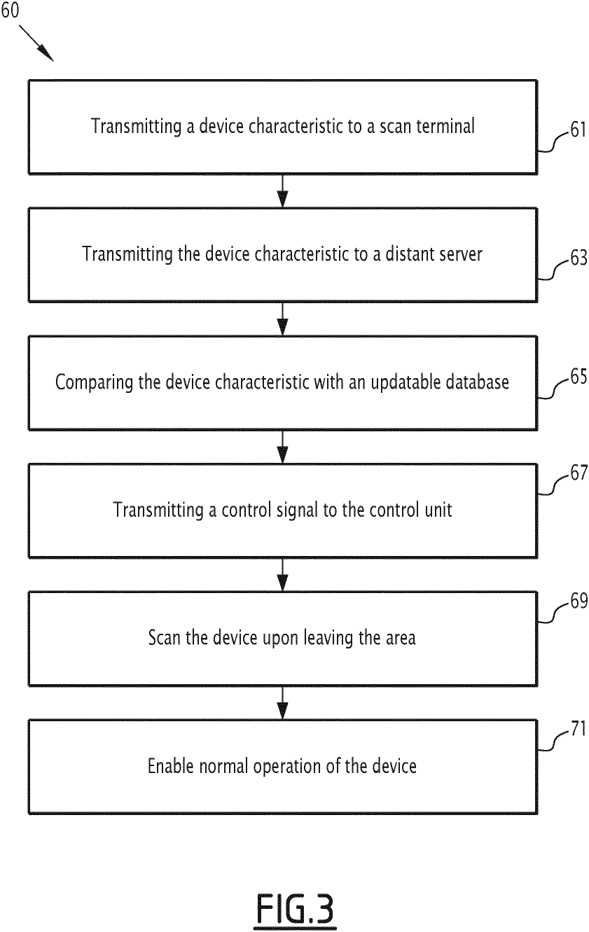

The preventing system 30 according to the first embodiment of the invention is able to perform a method 60 for preventing a non-authorized using of the aerosol generation device 10 which will be now explained in reference to FIG. 3.

Initially, it is considered that the aerosol generation device 10 is out of the restricted area.

During the initial step 61 of the preventing method 60, at least one device characteristic of the aerosol generation device 10 is determined. According to the first embodiment of the invention, this initial step 61 is performed by one of the scan terminals 34A, ..., 34N disposed at the entrance to the restricted area. For this purpose, upon entering the restricted area, a user scans the aerosol generation device 10 by bringing it to a close position with one of the scan terminals 34A, ..., 34N, for example with the scan terminal 34A. Thus, a first data exchange is performed between the communication units of the aerosol generation device 10 and the scan terminal 34A. This first data exchange comprises transmitting at least one device characteristic to the scan terminal 34A.

During the next step 63, the scan terminal 34A transmits the device characteristic to the distant server 36, eventually via the local server 35.

During the next step 65, the distant server 36 receives the device characteristic and compares it with the updatable database and notably, with the corresponding control characteristic(s). Thus, for example, if the transmitted characteristic is the brand and/or model of the aerosol generation device 10, the distant server compares this brand and/or model with a list of authorized or non-authorized brands or models of the updatable database.

If the transmitted characteristic is the emission composition of the aerosol generated by the device 10, the distant server 36 compares this emission composition with the corresponding emission thresholds of the updatable database. Based on this comparison, the distant server 36 generates the corresponding control signal.

In some embodiments, during this step 65, the distant server 36 can determine emission composition of the aerosol using for example only the brand and/or model of the aerosol generation device 10 or any other device characteristic such for example its identifier. In this case, the distant server 36 is for example able to access to an emission test report relative to this the brand and/or model of the aerosol generation device or any other device characteristic, in order to determine the emission composition of this device. Then, the distant server 36 can compare this emission composition with the corresponding emission thresholds of the updatable database. If for example the quantity of each component of the aerosol is less than the corresponding threshold in the updatable database, then the aerosol generation device is authorized to be used in the restricted area. If for example the quantity of at least one component of the aerosol is greater than the corresponding threshold in the updatable database, then the aerosol generation device is not authorized to be used in the restricted area.

For example, the updatable database can include a threshold relative to the quantity of Nicotine authorized in the restricted area. This quantity can be equal for example to 50 µg per 20 puffs. Thus, if according to an emission test report, the aerosol generated by the aerosol generation device contains 22.3 µg of Nicotine per 20 puffs, such a device can be authorized for using in the restricted area if the quantity of the other aerosol components are also less than the corresponding threshold. If according to the emission test report, the aerosol generated by the aerosol generation device contains 74.4 µg of Nicotine per 20 puffs, such a device cannot be authorized for using in the restricted area.

During the next step 67, the distant server 36 transmits the control signal to the communication unit 18 of the aerosol generation device 10 using for example the same scan terminal 34A, as during the initial step 61, and eventually the local server 35. In this case, it is considered that the aerosol generation device 10 is still in a close position with the scan terminal 34A which is able to perform a second data exchange. According to other embodiments, the control signal may be transmitted to the aerosol generation device 10 using any other suitable way, for example using the long-range communication capacities of the communication unit 18.

Upon receiving the control signal, the communication unit 18 of the aerosol generation device 10 transmits it to the control unit 20. The control unit 20 processes this control signal and determines the corresponding action which may comprise disabling the operation of the aerosol generation device 10, keeping it unchanged or adjusting the operational settings. In this last case, the control unit 20 may determine the adjusted operational settings using for example a pre-programmed routine or use adjusted operational settings comprised in the control signal.

The next two steps 69 and 71 can be optionally performed upon leaving the restricted area.

Particularly, during the step 69, one of the scan terminals 34A, ..., 34N, for example the scan terminal 34B scan the aerosol operation device 10. This step 69 is performed when for example the user leaves the restricted area and brings the aerosol generation device 10 in a close position with the scan terminal 34B.

During this step 69, the communication unit 18 of the aerosol generation device 10 transmits to the communication unit of the scan terminal 34B at least one characteristic such for example the device identifier.

During the next step 71, the communication unit of the scan terminal 34B transmits to the communication unit 18 of the aerosol generation device 10 a control signal causing enabling normal operation of the device. For this purpose, the scan terminal 34B transmits for example the device characteristic to the central server 36 or to the local server 35 which determines that the aerosol generation device 10 is already in the restricted area and that its scanning is performed upon leaving the area.

In variant, the scan terminal 34B is disposed at the exit from the restricted area and is designed to scan only when the user leaves the restricted area. In such a case, it can systematically transmit control signals causing enabling normal operation of the scanned aerosol generation devices, independently from their characteristics.

In another example of implementation of the first embodiment of the invention, the aerosol generation device 10 is associated to a mobile device like for example a smartphone. Particularly, in this context the term “associated” means that the aerosol generation device 10 is paired to the mobile device using for example the short-range capacities of the communication unit 18 of the aerosol generation device 10. For example, the aerosol generation device can be paired to the mobile device using the Bluetooth protocol. In this example of implementation, all or at least certain data exchanges of the aerosol generation device 10 with the scan terminals 34A, ..., 34N can be performed via the mobile device. Additionally, the mobile device can communicate at least one characteristic of the aerosol generation device 10 without requesting this characteristic from the control unit 20 or communication unit 18 of the device 10. Such a characteristic can be for example stored in a memory of the mobile device after its pairing with the aerosol generation device 10. Thus, upon entering the restricted area, the mobile device can be scanned by one the scan terminals 34A, ..., 34N and transmit at least one device characteristic to the distant server 36. Then, the mobile device can transmit the control signal generated by the distant server 36 to the aerosol generation device 10.

### Second Embodiment of the Invention

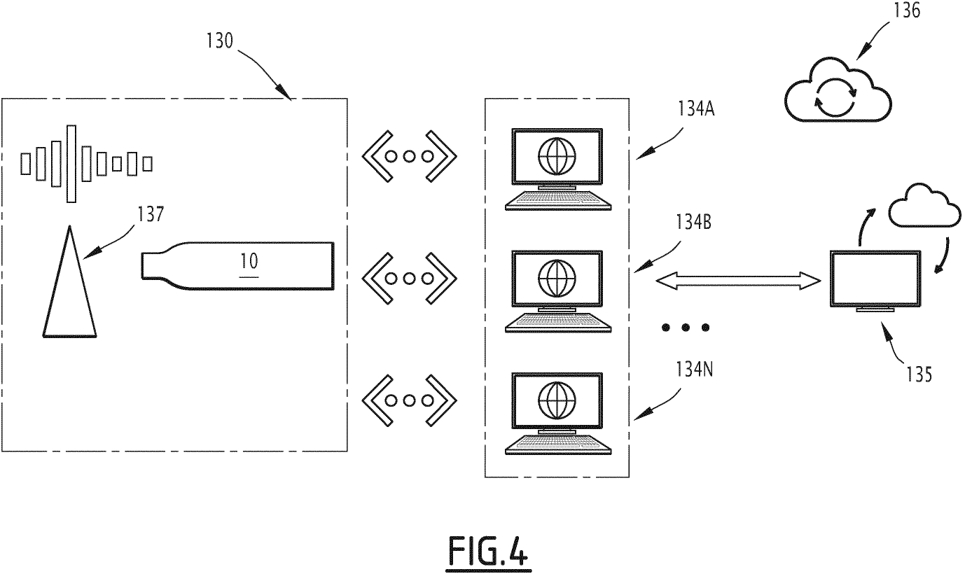

A system for preventing a non-authorized using of the aerosol generation device 10, as explained above, in a restricted area, according to a second embodiment of the invention will now be explained in reference to FIG. 4. This system is called hereinafter preventing system and denoted by reference 130 on this figure. Thus, as it is illustrated on FIG. 4, the preventing system 130 comprises a plurality of scan terminals 134A,..., 134N, a distant server 136 and at least one local emitter 137.

The scan terminals 134A, ..., 134N are similar to the scan terminals 34A, ..., 34N explained above. According to a particular example of implementation, the scan terminals 134A, ..., 134N are disposed only at the entrance to the restricted area.

The distant server 136 is also similar to the server 36 explained above and particularly, is able to communicate with the scan terminals 134A,..., 134N directly or indirectly, using a local server 135.

The local emitter 137 is able to emit a broadcast signal over the restricted area. Particularly, the local emitter 137 is configured to cover significantly integrally the restricted with the broadcast signal. In variant, several local emitters are disposed in the restricted area so as to cover it significantly integrally with the broadcast signal. The broadcast signal is able to cause disabling the operation of the aerosol generation devices situated in the restricted area.

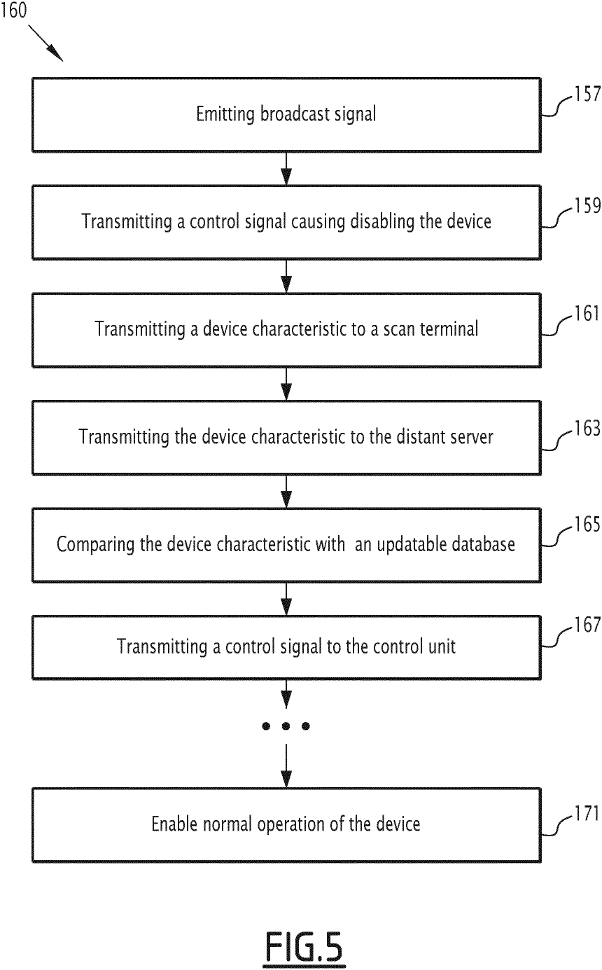

The preventing system 130 according to the second embodiment of the invention is able to perform a method 160 for preventing a non-authorized using of the aerosol generation device 10 which will be now explained in reference to FIG. 5.

Initially, it is considered that the aerosol generation device 10 is out of the restricted area.

During the initial step 157 of the preventing method 160, the emitter 137 emits the broadcast signal over the restricted area. This step 157 can be performed continuously.

During the step 159 performed upon entering the restricted area, the communication unit 18 of the aerosol generation device 10 receives the broadcast signal and transmits it to the control unit 20 of the device 10. The control unit 20 processes this signal and causes disabling the operation of the aerosol generation device 10.

The next step 161 is performed when for example a user wants to reactivate the operation of the aerosol generation device 10. For this purpose, the user brings it to a close position with one of the scan terminals 134A,..., 134N and at least one device characteristic is transmitted to this terminal. This step 161 is thus similar to the step 61 explained above.

The next steps 163 to 167 are similar to the steps 63 to 67 explained above.

Particularly, during the step 163, the corresponding terminal 134A, ..., 134N transmits to the distant server 136 the scanned device characteristic. During the step 165, the distant server 136 compares this characteristic with the updatable database and generates the corresponding control signal. During the step 167, the control signal is transmitted to the control unit 20 of the device 10 which enables normal or adjusted operation of the device, or keeps it disabled.

The next step 171 is performed upon leaving the restricted area. Particularly, in this case, the communication unit 18 of the aerosol generation device 10 does not receive any more the broadcast signal and transmits a control signal to the control unit 20 of the device 10 which enables normal operation of the device.

In another example of implementation of the second embodiment of the invention, the aerosol generation device 10 is associated to a mobile device like for example a smartphone. In this example of implementation, all or at least certain data exchanges of the aerosol generation device 10 with the scan terminals 134A, ..., 134N can be performed via the mobile device. Additionally, the broadcast signal issued from the emitter 137 can also be received and transmitted to the aerosol generation device 10, eventually in form of a control signal, by the mobile device.

### Third Embodiment of the Invention

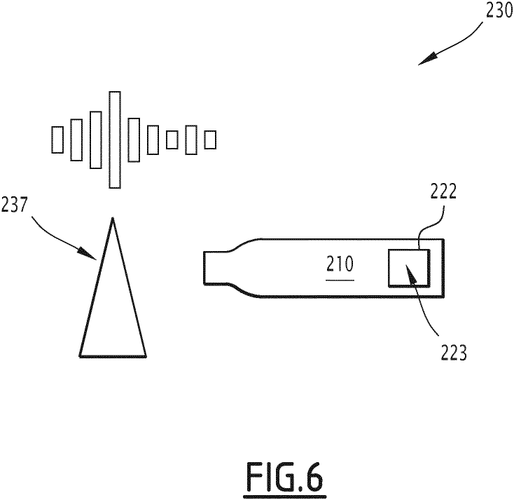

A system for preventing a non-authorized using of an aerosol generation device in a restricted area, according to a third embodiment of the invention will now be explained in reference to FIG. 6. This system is called hereinafter preventing system and denoted by reference 230 on this figure. Thus, as it is illustrated on FIG. 6, the preventing system 230 comprises an aerosol generation device 210 and at least one local emitter 237.

The aerosol generation device 210 is similar to the aerosol generation device 10 explained above and comprises at least the same components 12 to 20 as those explained above. Further, according to this embodiment, the aerosol generation device 210 comprises a processor 222 able to perform at least one pre-programmed routine, called hereinafter verification routine 223.

Additionally, according to this embodiment, the control unit 20 of the aerosol generation device 210 can further comprise a memory able to store the updatable database as explained above. This database can for example include thresholds of authorized emission composition of the aerosol in each known area and can be updated periodically using the communication unit 18.

According to another example of implementation, the updatable database is stored distantly. In this case, the control unit 20 of the device 210 is able to access to this database via the communication unit 18.

The emitter 237 is similar to the emitter 137 explained in relation with the second embodiment of invention. Like the emitter 137, the emitter 237 is able to emit a broadcast signal indicating entering to the restricted area. According to other examples of implementation, the broadcast signal can include identification data like for example an area identifier and/or thresholds of authorized emission composition of the aerosol in the area and/or brand or model of aerosol generations device authorized or non-authorized to be used in the area. In this case, the emitter 237 is connected for example to a distant server able to provide a database similar to the updatable database explained below.

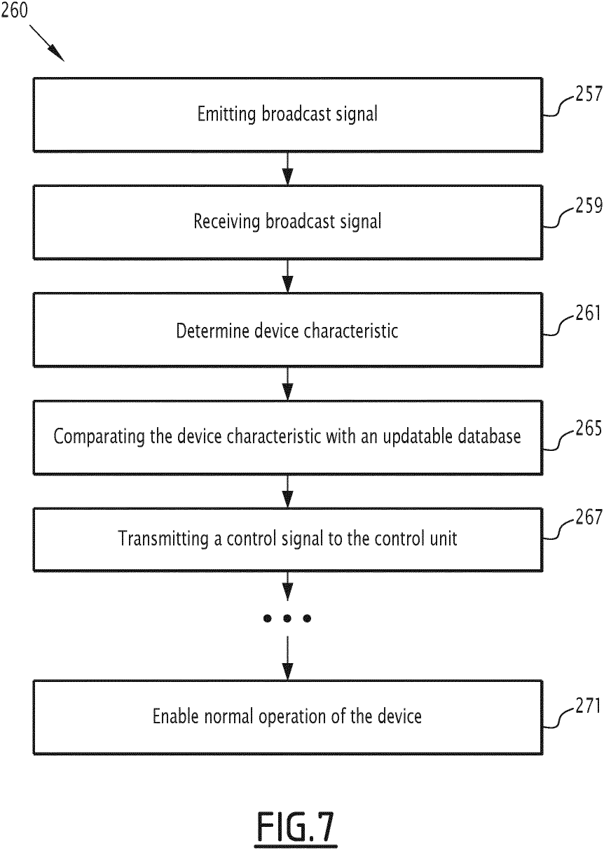

The preventing system 230 according to the third embodiment of the invention is able to perform a method 260 for preventing a non-authorized using of the aerosol generation device 210 which will be now explained in reference to FIG. 7.

Initially, it is considered that the aerosol generation device 210 is out of the restricted area.

During the initial step 257 of the preventing method 260, the emitter 237 emits the broadcast signal over the restricted area. Like in the previous case, this step can be performed continuously.

During the step 259 performed upon entering the restricted area, the communication unit 18 of the aerosol generation device 210 receives the broadcast signal and transmits it to the verification routine 223 which determines that the device 210 is in a restricted area and verifies if the device 210 is authorized or not to be used in this area during the next steps.

Particularly, during the next step 261, the verification routine 223 determines at least one device characteristic of the aerosol generation device 210.

During the next step 265, the verification routine 223 compares the determined device characteristic with the updatable database and further to this comparison, generates the corresponding control signal. The comparison of the device characteristic with the database can also include processing the broadcast signal. For example, when the broadcast signal comprises the area identifier, the verification routine 223 can determine emission restrictions according to the updatable database in this area and compare these restrictions with the emission composition of the aerosol generation device 210.

During the next step 267, the verification routine 223 transmits the control signal to the control unit 20 which processes this signal and causes disabling or adjusting the operation of the aerosol generation device 10.

The next step 271 is performed upon leaving the restricted area. Particularly, in this case, the communication unit 18 of the aerosol generation device 210 does not receive any more the broadcast signal and transmits a control signal to the control unit 20 of the device 10 which enables normal operation of the device.

### Fourth Embodiment of the Invention

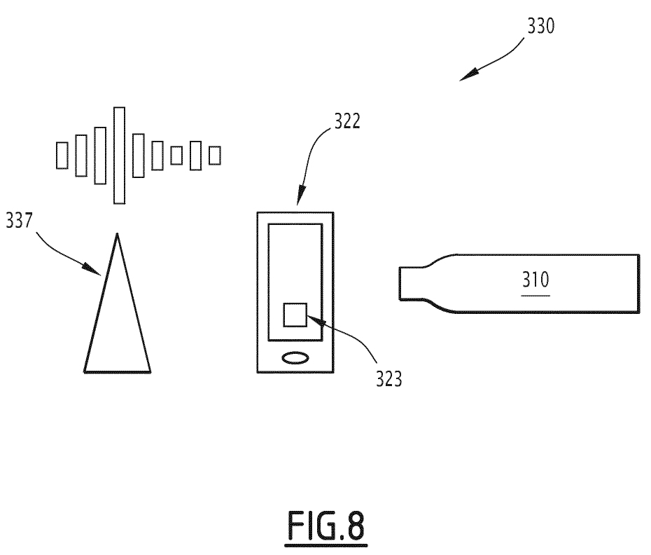

A system for preventing a non-authorized using of an aerosol generation device in a restricted area, according to a fourth embodiment of the invention will now be explained in reference to FIG. 8. This system is called hereinafter preventing system and denoted by reference 330 on this figure. Thus, as it is illustrated on FIG. 8, the preventing system 330 comprises an aerosol generation device 310, a mobile device 322 and at least one local emitter 337.

The local emitter 337 is similar to the local emitter 237 explained above and will not be explained in further detail.

The aerosol generation device 310 is similar to the aerosol generation device 10 explained also below.

The mobile device 322 is for example a smartphone paired to the aerosol generation device 310 using for example the short-range capacities of the communication unit 18 of the device 310. The mobile device 322 further comprises a processor able to perform a verification routine 323 similar to the verification routine 223 of the aerosol generation device 210 explained with the reference to the third embodiment of the invention.

The mobile device 322 is also able to receive and process the broadcast signal issued from the emitter 337.

The preventing system 330 according to the fourth embodiment of the invention is able to perform a method for preventing a non-authorized using of the aerosol generation device 310. This method is similar to the preventing method 260 explained below and differs from it in that the broadcast signal may be received by the mobile device 322 and in that the verification routine 323 is performed by the mobile device 322 and not by the aerosol generation device 310. In this case, the step of transmitting the control signal by the mobile device 322 to the control unit 20 is performed using the communication unit 18.

In another example of implementation of the fourth embodiment, at least some functionalities of the verification routine are performed by the mobile device 322 and at least some other functionalities are performed by the processor of the aerosol generation device 310. In this case, the functionalities of the verification routine are shared between the aerosol generation device 310 and the mobile device 322.

### Fifth Embodiment of the Invention

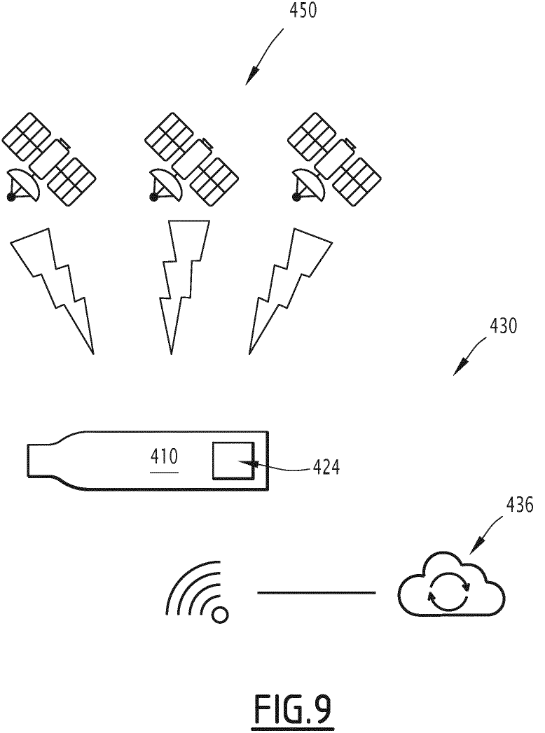

A system for preventing a non-authorized using of an aerosol generation device, in a restricted area, according to a fifth embodiment of the invention will now be explained in reference to FIG. 9. This system is called hereinafter preventing system and denoted by reference 430 on this figure. Thus, as it is illustrated on FIG. 9, the preventing system 430 comprises an aerosol generation device 410 and a distant server 436.

The distant server 436 is similar to the distant server 36 explained above. Particularly, it is able to store the updatable database explained above.

The aerosol generation device 410 is also similar to the aerosol generation device 10 explained above and comprises at least the same components 12 to 20 as those explained above. Further, according to this embodiment, the aerosol generation device 410 comprises a location receiver 424 able to localize the aerosol generation device 410. For example, the location receiver 424 uses a GNSS location system 450, like for example the GPS system, in order to determine the location of the device 410.

According to this embodiment, the aerosol generation device 410 may also store a map including restricted areas. This map can be for example updatable by the distant server 436 using for the example the long-range communication capacities of the communication unit 18 of the device 410.

The preventing system 430 according to the fifth embodiment of the invention is able to perform a method 460 for preventing a non-authorized using of the aerosol generation device 410 which will be now explained in reference to FIG. 9.

Initially, it is considered that the aerosol generation device 410 is out of the restricted area.

The initial step 459 of the preventing method 460 is performed upon entering the restricted area. In this step, the control unit 20 of the device 410 compares the location determined by the location receiver 424 with the stored map and determines that the aerosol generation device 410 is in a restricted area.

During the next step 461, the control unit 20 of the device 410 determines at least one characteristic of the device. This step is for example similar to the step 261 explained above.

During the next step 463, the control unit 20 of the device 419 transmits the determined device characteristic to the distant server 436 using for example the long-range communication capacities of the communication module 18.

During the next step 465, the distant server 436 compares the device characteristic with the updatable database and generates the corresponding control signal.

During the next step 467, the distant server 436 transmit the control signal to control unit 20 of the aerosol communication device 410 using the long-range communication capacities of the communication unit 18.

The next step 471 is performed when the control unit 20 of the device 410 compares the location determined by the location receiver 424 with the stored map and determines that the aerosol generation device 410 is out of any restricted area 20. In this case, it reactivates normal operation of the aerosol generation device 410.

According to another example of implementation of the fifth embodiment of the invention, the preventing system 430 further comprises a mobile device associated to the aerosol generation device 410. According to this example, the location receiver 424 is integrated into the mobile device and not into the aerosol generation device 410. In this case, the map including restricted area can be stored by the mobile device which can thus determine if the aerosol generation device 410 is in a restricted area or not. If so, the mobile device can perform all communications with the distant server 436 in place of the aerosol generation device 410 and transmit to the aerosol generation device only the resulting control command using for example the short-range communication capacities of the communication unit 18.

### Other Embodiments of the Invention

Other embodiments of the invention are still possible. These embodiments can combine different features of the previously described embodiments.

According to some embodiments, the control signal causing enabling, disabling or adjusting operation of the aerosol generation device can be generated basing further on restrictions other than the emission restrictions. These other restrictions can also concern the area or the user. Thus, for example, when a mobile device or any other device determines that the aerosol generation device is in a car, a control signal enabling normal or adjusted operation of the aerosol generation device can be sent only if the car is in autonomous driving mode. Other restriction scenarios in addition to the emission restrictions are still possible.

1. A method (60; 160; 260; 460) for preventing a non-authorized using of an aerosol generation device (10; 210; 310; 410) in a restricted area, the aerosol generation device (10; 210; 310; 410) comprising a control unit (20) configured to adjust the operation of the aerosol generation device (10; 210; 310; 410) according to operational settings upon receiving a control command;
the method (60; 160; 260; 460) comprising the following steps, performed when the aerosol generation device (10; 210; 310; 410) is in the restricted area :
determining (61; 161; 261; 461) a device characteristic of the aerosol generation device;
comparing (65; 165; 265; 465) the device characteristic of the aerosol generation device with an updatable database to generate a control signal for the aerosol generation device, the database comprising control characteristics of aerosol generation devices according to emission restrictions in the restricted area, the control characteristics authorizing use of the aerosol generation device according to its device characteristic if the aerosol generation device fulfills the emission restrictions in the restricted area;
transmitting (67; 167; 267; 467) to the control unit (20) of the device the control signal, the control signal causing determining adjusted operational settings to adjust the operation of the aerosol generation device according to the emission restrictions in the restricted area.

2. The method according to claim 1, wherein the device characteristic of the aerosol generation device is further determined according to a predetermined emission composition of the aerosol generated by this aerosol generation device.

3. The method according to claim 2, wherein the predetermined emission composition is obtained during a test or a series of tests to measure the quantity of components in the aerosol generated by one or several aerosol generation devices having the same device characteristic that the given aerosol generation device,
the predetermined emission composition being preferably publically accessible.

4. The method according to any one of the preceding claims, wherein each control characteristic of the updatable database comprises a threshold of authorized emission composition of the aerosol.

5. The method according to claim 4, wherein the device characteristic comprises an emission composition of the aerosol;
the control characteristics authorizing use of the aerosol generation device if the quantity of each component of the aerosol is less than the corresponding threshold in the updatable database,
the control characteristics preventing use of the aerosol generation device if the quantity of at least one component of the aerosol is greater than the corresponding threshold in the updatable database.

6. The method (260) according to any one of the preceding claims, wherein the device characteristic is determined by a processor of the aerosol generation device (210) by a pre-programmed routine.

7. The method (60; 160; 460) according to any one of the preceding claims, further comprising the step (63; 163; 463) of transmitting the device characteristic to a distant server (36; 136; 436).

8. The method (60; 160) according to claim 7, wherein the step (61; 161) of determining the device characteristic is performed by a scan terminal (34A,...34N; 134A,...,134N) upon entering the restricted area by scanning the aerosol operation device or a mobile device associated to the aerosol generation device;
the step (63; 163) of transmitting the device characteristic being performed by the scan terminal (34A,...34N; 134A,...,134N).

9. The method (60) according to claim 8, further comprising the following steps:
scanning (69) the aerosol operation device or a mobile device associated to the aerosol generation device by a scan terminal (34A,...,34N) upon leaving the restricted area;
transmitting (71) to the control unit (20) of the device a control signal causing normal operation of the aerosol generation device (10).

10. The method (460) according to claim 7, wherein the steps (461, 463) of determining and transmitting the device characteristic are performed by a mobile device associated to the aerosol generation device (410).

11. The method (160; 260) according to any one of claims 1 to 8, further comprising the following steps performed upon entering the restricted area:
emitting (157; 257) a broadcast signal indicating entering the restricted area;
transmitting (159; 259) to the control unit (20) of the device a control signal causing disabling the operation of the aerosol generation device when the broadcast signal is received;
transmitting (171; 271) to the control unit (20) of the device a control signal causing normal operation of the aerosol generation device when the broadcast signal is no more received.

12. The method (160; 260) according to claim 11, wherein the broadcast signal is received by the aerosol generation device or by a mobile device associated to the aerosol generation device.

13. The method (460) according to claim 1 or 7 or 10, further comprising a step (459) of determining a location of the aerosol generation device (410);
the control signal being generated further based on the location of the aerosol device using a memorized map including the restricted area.

14. The method (460) according to claim 13, wherein said steps are performed at least partially by the aerosol generation device (410) or by a mobile device associated to the aerosol generation device (410).

15. The method (60; 160; 260; 460) according to any one of the preceding claims, wherein the control signal is generated further based on restrictions imposed by the restricted area, other than the emission restrictions.

16. The method (60; 160; 260; 460) according to any one of the preceding claims, wherein each control characteristic of the updatable database comprises at least one element chosen in the group comprising:
brand and/or model of aerosol generation devices authorized or non-authorized to be used in the restricted area according to the emission restrictions ;
identifier of aerosol generation devices authorized or non-authorized to be used in the restricted area according to the emission restrictions ;
identifier of payloads authorized or non-authorized to be used in the restricted area according to the emission restrictions ;
thresholds of authorized emission composition of the aerosol.

17. The method (60; 160; 260; 460) according to any one of the preceding claims, wherein the device characteristic comprises at least one element chosen in the group comprising:
brand and/or model of the aerosol generation device ;
identifier of the aerosol generation device ;
identifier of the payload ;
emission composition of the aerosol.

18. The method (60; 160; 260; 460) according to any one of the preceding claims, wherein adjusting the operation of the aerosol generation device (10; 210; 310; 410) includes at least one element chosen in the group comprising:
heater temperature control;
aerosol composition control;
power control;
pressure control.

19. A system (30; 130; 230; 330; 430) for preventing a non-authorized using of an aerosol generation device (10; 210; 310; 410) in a restricted area, configured to perform the method (60; 160; 260; 460) according to any one of the preceding claims.
